(19) United States
(12) Patent Application Publication
(10) Pub. No.: US 2018/0352427 A1
(43) Pub. Date: Dec. 6, 2018

(54) PROTECTIVE DEVICE FOR PROTECTING THE PRIVACY OF A PERSON

(71) Applicant: SIEMENS AKTIENGESELLSCHAFT, München (DE)

(72) Inventor: RICARDA WEBER, UNTERSCHLEISSHEIM (DE)

(21) Appl. No.: 15/776,307

(22) PCT Filed: Oct. 26, 2016
(86) PCT No.: PCT/EP2016/075768

§ 371 Date: May 15, 2018

(30) Foreign Application Priority Data
Nov. 18, 2015 (DE) 10 2015 222 794.4

(51) Int. Cl. H04W 12/02; G06F 21/62

(52) U.S. Cl. CPC H04W 12/02; H04L 67/12; G06F 21/6245

(57) ABSTRACT

An IoT system is provided, including a plurality of IoT sensors for detecting data which can be evaluated by a data evaluation unit of the IoT system, wherein the IoT system includes detectors for the detection of protection signals (SS) which signal in each case an acceptance or refusal of a person for detecting and/or processing and/or storing and/or relaying and/or evaluating person-related data of the person concerned.

### CROSS-REFERENCE TO RELATED APPLICATIONS

This application claims priority to PCT Application No. PCT/EP2016/075768, having a filing date of Oct. 26, 2016, based on German Application No. 10 2015 222 794.4, having a filing date of Nov. 18, 2015, the entire contents both of which are hereby incorporated by reference.

### FIELD OF TECHNOLOGY

The following relates to a protective device for protecting the privacy of a person, in particular in an IoT (Internet of Things) system.

### BACKGROUND

Devices from all domains of daily life are increasingly interconnected. Communication among devices occurs by means of sensors, detectors and data networks that, for their part, form a global network by interlinking.

The so-called Internet of Things refers to the electronic networking of objects from people's daily life. In the Internet of Things, clearly identifiable physical objects and devices are linked with a data representation within the global network. In addition to the human subscribers and people, the subjects of this network also include objects and devices that communicate with each other. An IoT system can have a multitude of different IoT sensors, which record data in their respective environments. IoT sensors can record factors such as locations, temperatures or speed of movement and provide this information to a local or remote data processing unit for data evaluation. An Internet of Things or IoT system can be employed in a wide range of application areas, such as in the fields of electrical power supply, building automation, healthcare or logistics and transport. IoT applications can make many different services available to users. For example, an in-car service can support a user in the search for a parking spot within an urban area or can locate the nearest pharmacy for the user. For this purpose, the IoT sensors can be permanently mounted in a particular area, such as on a building, or can also be mobile. The clothing worn by users or persons is increasingly being outfitted with IoT sensors that transmit personal data to the IoT system.

In the traditional environment, personal data already include far more than just the name and address of a person, such as those explained in the article “Seven Types of Privacy” by Rachel L. Finn, David Wright and Michael Friedewald, in S. Gutwirth et al, “European Data Protection: Coming of Age,” Dordrecht: Springer Science and Business Media, 2013, (URL: http://works.bepress.com/michael_friedewald/60/).

Personal data encompass data that relate to human individuals and that make it possible to identify these individuals either directly or after analysis and evaluation and, if necessary, correlation and fusion with other sources of information that are actually or potentially available to the data processor, even without a name being associated with the data, and to draw conclusions about aspects of the individual, which are associated with his or her privacy, such as his or her physical person, behavior, activities, communications, images, thoughts, feelings, place of residence or contacts.

The “36th International Privacy Conference of the Data Protection and Privacy Commissioners”, Republic of Mauritius, website, October 2014, (URL: http://www.govmu.org/English/News/Pages/Mauritius-Hosts-36th-International-Conference-of-Data-Protection-and-Privacy-Commissioners.aspx), as well as the “Article 29 Data Protection Working Party, Opinion 8/2014 on the on Recent Developments on the Internet of Things”, Technical Report 14/EN WP 223, European Union, September 2014, (URL: http://ec.europa.eu/justice/data-protection/article-29/documentation/opinion-recommendation/files/2014/wp223 en.pdf), recommends considering all IoT sensor data as personal data and treating it accordingly from the start of data collection.

The increasing flood of personal data significantly limits people's privacy. People usually have no control over where the recorded personal data is saved and for what purposes it is analyzed.

US 2012/0 222 083 A1 discloses a network in which access rights to individual services and/or systems are granted or denied on the basis of profiles, so-called “privacy profiles”.

WO 2014/175 721 A1 likewise discloses a system in which a so-called “privacy access policy” is used to regulate access to data by services.

“The Internet of Things: A Survey from the Data-Centric Perspective” by C. C. Aggarwal provides an overview of the Internet of Things, which also includes the problem of data security.

A problem addressed by embodiments of the present invention is that of providing a device and a method for protecting the privacy of natural persons.

### SUMMARY

The implementation potential for respecting the wishes of said person in terms of his or her privacy depends upon the configuration of the concrete IoT system.

In one possible embodiment of the protective device according to embodiments of the invention, the protective device is a hardware token that can be carried by a person. This hardware token is preferably a hardware token that has been certified by a trustworthy authority.

In a further possible embodiment of the protective device according to embodiments of the invention, the signaling unit is an active signaling unit with a transmitter that emits a protection signal, which signals the approval or denial of permission by the person in question to record and/or process and/or store and/or disseminate and/or evaluate his or her personal data in general or for particular IoT applications.

In an alternative embodiment, the signaling unit is a passive signaling unit that, upon receiving a query signal, sends back a protection signal, which signals the approval or denial of permission by the person in question to record and/or process and/or store and/or disseminate and/or evaluate his or her personal data.

In a further possible embodiment of the protective device according to embodiments of the invention, the signaling unit of the protective device can be activated or deactivated by a person via an interface.

In another possible embodiment of the protective device according to embodiments of the invention, the protection signal emitted by the signaling unit is a radio signal, the range of which corresponds substantially to the range of IoT sensors of a corresponding IoT system.

In a further possible embodiment of the protective device according to embodiments of the invention, the protection signal emitted by the person's protective device switches additional devices that are worn by the same person or that are or can be assigned to the person, in particular a mobile radio device or a fitness tracker, to a protective operating mode to protect the privacy of the person in question.

In one possible embodiment of the IoT system according to embodiments of the invention, the protection signal is emitted by a portable protective device to protect a person's privacy, wherein the protective device has a signaling unit, which signals the approval or denial of permission by a person to record and/or process and/or store and/or disseminate and/or evaluate his or her personal data that are detected by IoT sensors of the IoT system.

In a further possible embodiment of the IoT system according to embodiments of the invention, after detecting a protection signal emitted by a protective device, the IoT system switches to a protective operating mode to protect the person's privacy from the recording and/or processing and/or storage and/or dissemination and/or evaluation of the personal data of the person in question.

In another possible embodiment of the IoT system according to embodiments of the invention, the person's IoT system confirms the detection of the protection signal emitted by his or her protective device.

In a further possible embodiment of the IoT system according to embodiments of the invention, when in the protective operating mode, the IoT sensors of the IoT system detect data only coarsely and/or the IoT system stores data only briefly and/or analyzes these data only to a limited extent.

According to a further aspect, embodiments of the invention provides a data acquisition device for recording data.

In one possible embodiment of the data acquisition device according to embodiments of the invention, the data acquisition device is integrated into a smart meter measuring device or is associated with a smart meter measuring device for measuring the power consumption within a person's household.

In an additional possible embodiment of the data acquisition device according to embodiments of the invention, the data acquisition device is integrated into a fitness marker or is associated with a fitness tracker for measuring a person's body functions.

According to a further aspect, embodiments of the invention provides the user with a mobile radio device.

According to a further aspect, embodiments of the invention provides a protective signal detector for detecting a protection signal.

In one possible embodiment of the protective signal detector according to embodiments of the invention, the protective signal detector can be linked via a data interface to a portable device, in particular a portable mobile radio device or a portable data acquisition device. In another possible embodiment, the protective signal detector is integrated into or associated with an IoT sensor or data acquisition device.

According to a further aspect, embodiments of the invention also provides a method for protecting the privacy of a person.

Hereafter, possible embodiments of the various aspects of embodiments of the invention will be explained in greater detail with reference to the accompanying figures.

### BRIEF DESCRIPTION

Some of the embodiments will be described in detail, with reference to the following figures, wherein like designations denote like members, wherein:

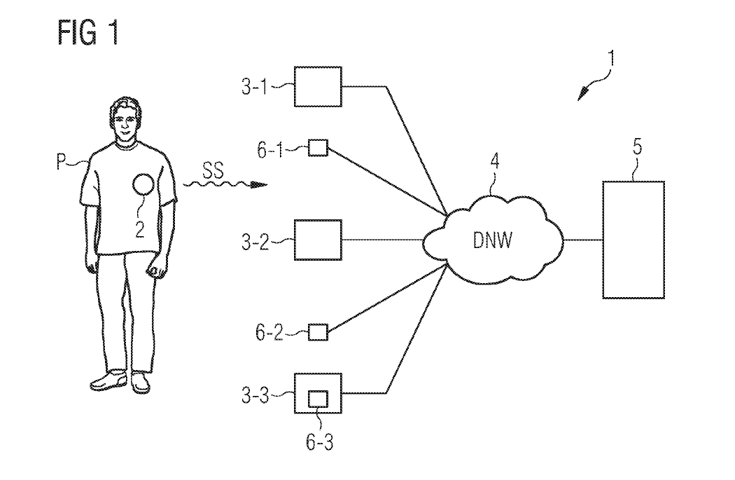

FIG. 1 shows a schematic representation of an IoT system that employs a protective device to protect the privacy of a person;

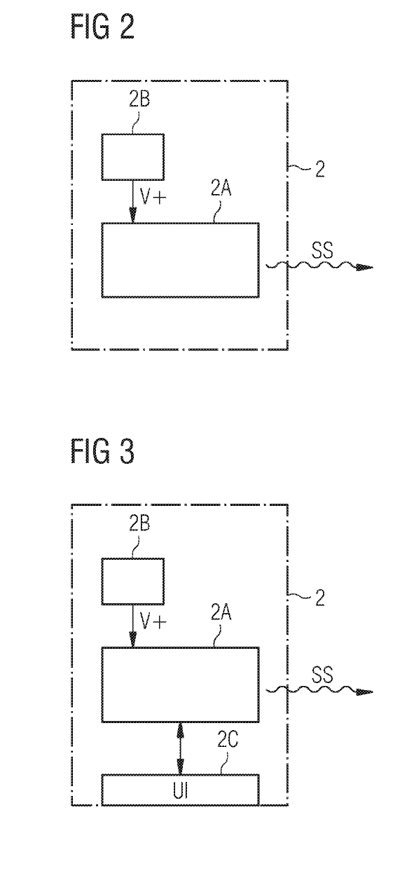

FIG. 2 shows a block diagram to represent an embodiment of a protective device;

FIG. 3 shows a block diagram to represent a further embodiment of a protective device;

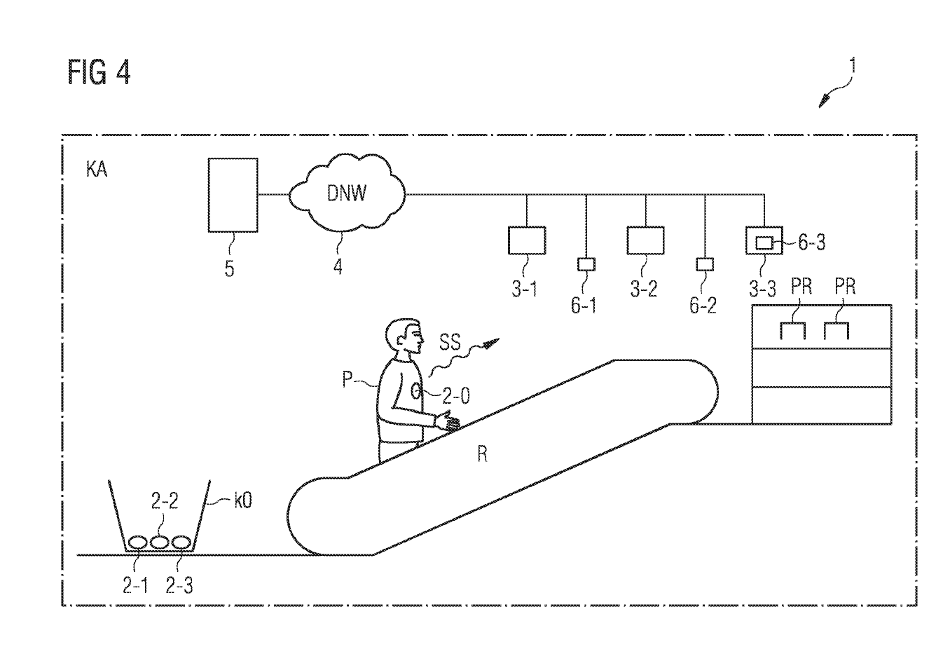

FIG. 4 shows a schematic representation of an IoT system, in which the protective device can be used;

FIG. 5 shows a schematic representation to represent a further exemplary IoT system, in which the protective device can be used;

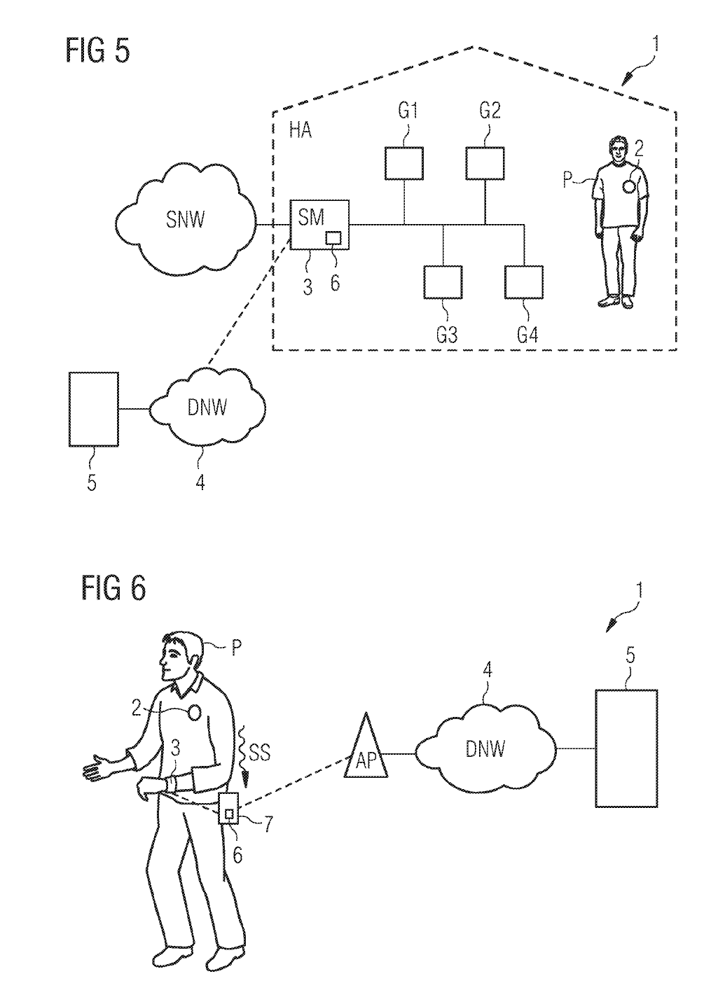

FIG. 6 shows a schematic representation of a further exemplary IoT system, in which the protective device can be used;

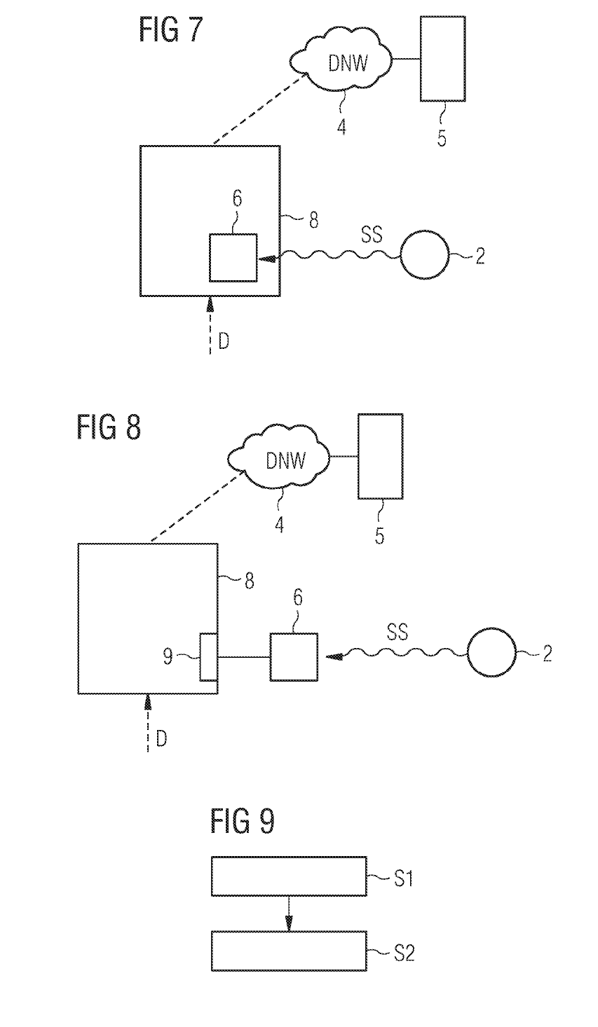

FIG. 7 shows a schematic representation of a first embodiment of a detector for detecting a protection signal;

FIG. 8 shows a schematic representation of a further exemplary embodiment of a detector for detecting a protection signal;

FIG. 9 shows a simple flow chart to represent an exemplary embodiment of a method for protecting the privacy of a person.

### DETAILED DESCRIPTION

FIG. 1 schematically shows an exemplary embodiment of an IoT system 1 according to embodiments of the invention, in which a protective device 2 according to embodiments of the invention can be used to protect the privacy of a person P. As can be discerned in FIG. 1, a person P carries a protective device 2 with him or her to protect his or her privacy. This protective device 2 is preferably a portable hardware token that, for example, is applied to the clothing of the person P who is to be protected. For instance, the protective hardware token 2 can be attached to an article of clothing or carried in a pocket of the article of clothing worn by the person P. The protective device 2 comprises a signaling unit, which signals the approval or denial of permission by the person to record and/or process and/or store and/or disseminate and/or evaluate the personal data of said person P that can be recorded by IoT sensors 3-1, 3-2, 3-3 of the IoT system 1. The number and type of the various IoT sensors 3-i can vary for different fields of application. The IoT sensors 3-i can be optical or acoustic sensors, for example, which provide relevant sensor data about a data network 4 to a data processing unit 5 of the IoT system 1 for an evaluation of the data. The data network 4 can be the Internet, for instance. Alternatively, the data network 4 can also be a local network, such as one within a building. In addition to the IoT sensors, the IoT system 1 also has detectors for a protection signal SS emitted by the protective device 2. In the exemplary embodiment shown in FIG. 1, the IoT system 1 has detectors 6-1, 6-2, 6-3. These protective signal detectors 6-i can be linked to the data network 4 separately or, for example, a detector 6-3 can be integrated into an IoT sensor 3-3.

The protection signal SS signals the approval or denial of permission by the person P to record and/or process and/or store and/or disseminate and/or evaluate the personal data of person P that is detected by the IoT sensors 3-i. For example, a person P can attach a protective device 2 to his or her clothing at an entrance of a building so that it signals approval or denial of permission to evaluate his or her personal data during his or her movement within the building. In one possible embodiment variant, an attached protective device 2 signals a denial by the person P in question to evaluate his or her personal data by a data processing unit of the IoT system. In an alternative embodiment variant, a person P can also explicitly express or signal approval for further data evaluation of his or her personal data by attaching a protective device 2. In a further embodiment variant, a person P can choose between different types of protective devices and/or hardware tokens when entering a building, for instance, wherein a first type of protective devices signals an approval and another type signals a denial of permission to perform further data evaluation on the personal data. In another embodiment variant, the person P in question can actuate an input unit and/or a switch when attaching the protective device 2, wherein, depending upon the switch setting, either a protection signal is emitted to signal the person's approval or a protection signal is emitted to signal his or her denial of permission by means of a signaling unit of the protective device 2.

The protective device 2 carried by the person P is preferably a light-weight hardware token that is integrated within a housing and that has a signaling unit located inside it. In one possible embodiment of the protective device 2 according to embodiments of the invention, the signaling unit that is integrated in the hardware token is an active signaling unit, which contains a transmitter that emits at least one protection signal SS. In one possible embodiment, the protective hardware token 2 is a certified token. For example, the protective device 2 can be certified by an appropriate control authority. In one possible embodiment of the protective device 2 according to embodiments of the invention, the transmitter in the signaling unit transmits an anonymous protection signal SS, which can be detected by the corresponding detectors 6-i of the IoT system 1. Thereby, the protection signal in one possible embodiment can be formed by a radio signal, the range of which substantially corresponds to the range of the IoT sensors 3-i of the IoT system 1.

In one possible embodiment, the protection signal SS that is emitted by the protective device 2 of the person P can switch other devices carried by the person P to a protective operating mode and/or can influence them in order to protect the privacy of the person P. For instance, if the person P is carrying a mobile radio device, one possible embodiment of this mobile radio device provides that it is likewise automatically switched to a protective operating mode by an integrated or attached detector when the protection signal SS is detected in order to protect the privacy of the person P. In this way, a person P can move anonymously within a building without geolocation data, for example, being transmitted by the mobile radio device.

The IoT system 1 has a multitude of different IoT sensors 3-i for recording data, which can be evaluated by at least one data evaluation unit of the IoT system 1.

In order to protect the privacy of the person P in question, one possible embodiment of the IoT system provides that, after detecting a predetermined protection signal SS emitted by a protective device 2 of a person P, it automatically switches from a normal operating mode to a protective operating mode, in which the recording and/or processing and/or storage and/or dissemination and/or evaluation of the personal data of the person P in question either ceases completely or continues only to a limited extent.

In one possible embodiment of the IoT system 1 shown in FIG. 1, the detection of a protection signal SS by a detector 6-i of the IoT system 1 is confirmed by the IoT system of the person P who is wearing or carrying the protective device 2. For example, the detection of the transmitted protection signal SS can be displayed to the person P on an optical display unit located for example in the vicinity of the associated IoT sensor 3-i. Alternatively, the IoT system itself can transmit a signal to a receiver located within the portable protective hardware token 2 in order to acknowledge the detection of the protection signal SS. Upon receiving the acknowledgement signal, the portable protective hardware token 2 can, for example, give a vibrating response or illuminate an LED to signal to the person P that the protection signal SS has been detected by the IoT system 1 and his or her privacy is accordingly being protected.

In one possible embodiment of the IoT system according to embodiments of the invention, data are detected only coarsely by the IoT sensors 3-i after switching to the protective operating mode. For example, location data about the place of residence of the person P are coarsely detected with low local resolution and/or evaluated by the IoT system 1. For example, the location data detected by sensors can indicate that the person P is in a particular larger region or building but not the exact location.

FIG. 2 shows a simple block diagram to represent an exemplary embodiment of a protective device 2 according to embodiments of the invention for protecting the privacy of a person P who is wearing or carrying the protective device 2. In the exemplary embodiment shown, the protective device 2 comprises a signaling unit 2A, which signals approval or denial of permission to record and/or process and/or store and/or disseminate and/or evaluate the personal data of the person P in question. In one possible embodiment, the signaling unit 2A contains a transmitter that emits a predetermined protection signal SS, such as a radio signal with a particular frequency. In one possible embodiment, the protective device 2 includes an integrated energy supply unit 2B, which provides the signaling unit 2A with power. In an alternative embodiment, the protective device 2 can also be a passive protective device that generates and transmits a corresponding protection signal SS only once a query signal has been received, wherein the energy required to do so is obtained from the query signal.

FIG. 3 shows a further exemplary embodiment of the protective device 2 according to embodiments of the invention for protecting the privacy of a person P. In the exemplary embodiment shown in FIG. 3, the protective device 2 additionally has a user interface 2C. By means of this user interface 2C, a person P carrying a protective device 2 can activate or deactivate the transmission of a protection signal SS by said protective device 2. In another possible embodiment, the person P can employ the user interface 2C to choose whether the transmitted protection signal SS signals the approval or denial of permission to record and/or process and/or store and/or disseminate and/or evaluate his or her personal data. Further embodiments are possible. For instance, in one possible further embodiment variant, the protective device 2 has a receiver for receiving an acknowledgement signal from the IoT signal 1. This acknowledgement signal acknowledges the receipt of the protection signal SS by a corresponding detector 6-i of the IoT system 1. Said acknowledgement signal can activate an actuator which is integrated in the protective device 2 and which, for example, causes the housing of the protective device 2 to vibrate or illuminates an LED in order to indicate to the person P the successful detection of the protection signal SS by the IoT system 1.

FIG. 4 schematically shows an example of the use of an IoT system 1, in which the protective device 2 according to embodiments of the invention can be used. In the use example shown in FIG. 4, the person P enters a department store KA, where a basket KO is located in the entrance area. The basket KO contains various protective devices and/or hardware tokens 2-i, which a person P can remove from the basket KO and attach to his or her clothing. In the example shown in FIG. 4, a person P has fastened a protective hardware token 2-0 to his chest and is riding an escalator R to a first floor of the department store KA. Various products PR that the person P can consider for purchase are located on a shelf there. The behavior of the person P while shopping, such as which products PR the person P considers or in front of which shelves the person P stops, can be monitored and/or observed by various IoT sensors 3-i of the IoT system 1. The protection signal SS emitted by the protective device 2-0 of the person P is detected by signal detectors 6-i in the IoT system 1 shown in FIG. 4. After detection of the protection signal SS, which signals the denial of permission by the person P to record and/or process and/or store and/or disseminate and/or evaluate his or her personal data, for instance, the IoT system 1 is automatically switched to a protective operating mode to protect the privacy of the person P. In said protective operating mode, the detected personal data of the person P are then for example either not detected at all or are immediately deleted or not evaluated or else evaluated only to a limited extent. In one possible embodiment, the detection of the protection signal SS by one of the detectors 6-i can be acknowledged by the IoT system 1 by the transmission of an acknowledgement signal, and so the person P knows that his or her privacy is protected during the buying process. When leaving the department store KA, the person P can return the protective hardware token 2-0 he or she has been carrying to the basket KO.

FIG. 5 shows a further example of the use of an IoT system 1 according to embodiments of the invention. In the exemplary embodiment shown, a person P is located within his or her own private residence HA. Various devices and/or household appliances G1, G2, G3, G4 are set up in the residence HA and form a local power grid, which is linked to a power supply network SNW via a smart meter measuring device. The smart meter measuring device forms an IoT data sensor 3 of the IoT system 1. The smart meter 3 records the individual power usage within the residence HA of the person P. In the exemplary embodiment shown in FIG. 5, the smart meter measuring device 3 has integrated into it a detector 6 that can detect a protection signal SS emitted by a protective hardware token 2 of the person P. During normal operations, the smart meter 3 transmits the current data via a data network 4 to a remote data processing unit 5, such as a server of the power network operator, for data evaluation. In the process, the protection signal SS emitted by the protective hardware token 2 can signal that the customer or person P agrees to allow his or her individual power consumption data to be evaluated only in a particular way. For example, the protection signal SS could indicate that the power network operator may not share with other institutions or organizations any electricity-related data that were detected in the presence of the person P. Alternatively, a protection signal SS that is emitted by the protective hardware token 2 and detected by the detector 6 of the smart meter measuring device can indicate, for example, that the individual electricity usage data of electricity customer P should be recorded only locally and should not be transmitted over the data network 4 to a remote data processing unit 5, or that the current data may be shared only after they are accumulated into less specific intervals of time as long as the person P is located in the residence.

FIG. 6 shows a further example of the use of an IoT system 1 according to embodiments of the invention, in which a protective device 2 can be employed to protect the privacy of a person P. In the example shown in FIG. 6, the person P carries a so-called fitness tracker that is attached e.g. to a wrist of the person P during a sports activity, for example. This fitness tracker forms an IoT sensor 3 of the IoT system 1 and continuously generates sensor data that measure body functions, such as the heart rate of the person P. The person P is carrying a mobile terminal, such as a smartphone 7, in the use example portrayed here. A detector 6 for detecting a protection signal SS that is emitted by the protective device 2 is provided in the smartphone 7 in the exemplary embodiment shown. Said detector 6 can be linked to the mobile terminal 7 via a data interface or it can be integrated within the mobile terminal 7. The protection signal SS detected by the detector 6 is transmitted by a transmitting unit of the mobile terminal 7 via an air interface to an access point AP. In one possible embodiment, the received protection signal SS can result in the IoT system 1 switching from a normal operating mode to a protective operating mode. Moreover, the protection signal SS that is detected by the detector 6 of the mobile terminal 7 can result in the sensor data emitted by the fitness tracker 3 being processed in a corresponding way. For instance, a data stream can be interrupted by body sensor data that are transmitted by the mobile terminal 7 for the access point to an evaluation unit 5 of the IoT system 1. Alternatively, the transmission of the sensor data can also be carried out selectively or coarsely in reaction to a detected protection signal SS. Furthermore, particular functions of the mobile terminal 7, such as a smartphone, can be deactivated by a detected protection signal SS. In one possible embodiment, a person P has his or her own protective device 2, which he or she wears or carries in various situations, such as when shopping in a department store, as represented in FIG. 4, during sports activities, as represented in FIG. 6, or while in his or her own home, as represented in FIG. 5. Alternatively, a person P can temporarily carry in certain situations a protective hardware token available on site, such as by taking the protective hardware device 2 from a basket and attaching it to his or her clothing.

FIGS. 7 and 8 show embodiment variants for protective signal detectors 6 according to embodiments of the invention for the detection of a protection signal SS. In the embodiment variant shown in FIG. 7, the protective signal detector 6 of the IoT system 1 is integrated in a device, such as a data acquisition device 8. As soon as a predetermined protection signal has been detected by the detector 6, data D, in particular personal data, are dismissed or processed accordingly in order to protect the privacy of the person P in question.

In the embodiment variant shown in FIG. 8, the protective signal detector 6 is not integrated within the device 8 but rather is linked to the data device via a data interface 9. The protective signal detector 6 serves to detect a protection signal SS, which signals the approval or denial of permission by the person P to record and/or process and/or store and/or disseminate and/or evaluate his or her personal data.

FIG. 9 shows a flow chart to represent an exemplary embodiment of the method according to embodiments of the invention for protecting the privacy of a person P.

In a first step S1, a protection signal SS is sent out by a protective device 2 carried by a person P. In the process, the transmitted protection signal SS signals the approval or denial of permission by the person P to record and/or process and/or store and/or disseminate and/or evaluate the personal data of the person P.

In a further step S2, the transmitted protection signal SS is detected by a signal detector 6 of an IoT system 1, whereupon said IoT system 1 switches to a protective operating mode to protect the privacy of the person P in question.

The method and the system according to embodiments of the invention are versatile. A person P and/or user who enters the detection range of an IoT sensor of an IoT system 1 is usually unaware of the fact, and so data detection by an IoT sensor normally cannot be prevented without the use of a protective hardware token 2 according to embodiments of the invention. The system according to embodiments of the invention makes it possible for a person P to declare whether he or she fundamentally approves or denies permission for any measured values originating from or significantly influenced by him or her to be recorded by sensors and then processed and/or stored and/or disseminated and/or analyzed, without thereby having to reveal his or her identity.

In a manner of speaking, the portable protective device 2 according to embodiments of the invention represents a privacy protector or a consent/non-consent token, with which the person P can declare to any IoT system his or her approval or denial of permission to record and/or process and/or store and/or disseminate and/or evaluate his or her personal data. The protective hardware token 2 signals to an IoT system 1 and its sensors that an unidentified data object and/or unidentified person P is located within its detection range and has either declared their agreement or, conversely, expressly denied permission to collect and evaluate data. The protective devices 2 permit the IoT system to be able to react appropriately to the presence of different persons P. Some of the persons present might be carrying a protective device 2 for protecting their own privacy, while another portion of the persons present might not have a protective device 2 with them to protect their respective privacy.

The protective device 2 preferably has the form of an anonymous, unidentifiable and untraceable physical hardware token. By carrying this hardware token 2, the bearer or person P signals his or her permission or express denial of permission for particular or moreover any IoT applications. In one possible embodiment, the protective device 2 also allows a person P to use different IoT applications on the protective device, for instance by placing it on a corresponding reader/writer of the IoT system 1. The protective device can then address these IoT applications in a dedicated fashion in one possible embodiment. In one possible embodiment, corresponding protective signal detectors 6 of the IoT system 1 receive the signals emitted by the protective hardware token 2 and forward them to IoT applications. As a rule, the protective signal detectors 6 are integrated in or combined with the sensors 3-i of the IoT system 1. Alternatively, separate protective signal detectors 6 can be applied in a particular area.

The protection signal SS emitted by the protective device 2 preferably does not contain any recognizable identity features of the person P. In order to give data subjects or persons P who deny permission sufficient assurance that the protective hardware token 2 transmits only required data and no other data, the protective device 2 is preferably certified by an appropriate trustworthy control or service authority.

In one possible embodiment, an operator of an IoT system 1 informs potential data subjects or persons P about the coverage area of its IoT application. Moreover, the IoT application or IoT system operator can inform potential data subjects about where said data subject or person P can get appropriate protective devices 2 to protect his or her privacy. A person P who knows that he or she is entering the coverage area of an IoT application or IoT system 1 can obtain suitable protective devices 2 in the location indicated and subsequently can carry them with him or her. If an IoT application or one of the protective signal detectors 6 receives a protection signal SS from a portable protective device 2, the IoT application can react in accordance with agreements and rules and, for example, does not record any personal data or else handles recorded personal data appropriately, such as deleting it, and/or does not process the data or processes the data only to a limited extent. This permits the IoT application to respect and protect the privacy of the person P accordingly.

Should there be a desire to temporarily suppress the signal transmission of the protection signal SS and thus to temporarily suspend privacy protection, protective covers can be used, for example, which cannot be penetrated by the radio signals of the hardware token 2. Alternatively, a switch provided for this purpose can be included on the protective device.

The IoT system 1 according to embodiments of the invention allows people to signal their consent or denial of permission to record, store, process, disseminate and analyze data by a particular IoT application or by the IoT system 1 as a whole in a way that is machine-detectable and simple, with a manageable level of complexity and without media discontinuities. Reliably determining the permission status of the present persons P by an explicit declaration and signaling then allows an IoT application of an IoT system 1 to comply with these wishes of the persons on the premises and thus to proceed in accordance with agreements and rules. In so doing, the IoT system 1 can adapt the degree of detail with which the data is recorded, stored and processed as a function of the permission status of the data subjects or persons in question. In particular, the unregulated data evaluation of selective personal data can be limited and/or prevented by the IoT system 1 according to embodiments of the invention.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A protective device for protecting the privacy of a person, having a signaling unit that signals the approval or denial of permission to record personal data of the person by means of IoT sensors of an IoT system and/or to process, store, disseminate and/or evaluate the personal data of the person that can be recorded by IoT sensors of an IoT system;
wherein the protective device has a hardware token that can be carried by the person, wherein said token can be certified;
wherein the signaling unit is an active signaling unit having a transmitter that transmits a protection signal or is a passive signaling unit that sends back the protection signal upon receipt of a query signal; and
wherein the protection signal signals the approval or denial of permission by the person to record and/or process and/or store and/or disseminate and/or evaluate the personal data in general or for IoT applications.

2. The protective device as claimed in claim 1,
wherein the transmitter in the signaling unit transmits an anonymous protection signal, which can be detected by the corresponding detectors of the IoT system.

3. The protective device as claimed in claim 1
wherein the signaling unit can be activated and deactivated by the person.

4. The protective device as claimed in claim 1
wherein the protection signal emitted by the signaling unit is a radio signal, the range of which corresponds substantially to the range of IoT sensors of the IoT system.

5. The protective device as claimed in claim 1,
wherein the protection signal emitted by the protective device of the person switches other devices carried by or personally associated with the person, selected from a mobile radio device or a fitness tracker, to a protective operating mode to protect the privacy of the person.

6. An IoT system having a multitude of IoT sensors for recording data that can be evaluated by a data evaluation unit of the IoT system, wherein
the IoT system comprises detectors for detecting protection signals, which signal either the approval or denial of permission by a person to record and/or process and/or store and/or disseminate and/or evaluate the personal data of the person in question; wherein the protection signal is emitted by a portable protective device for protecting the privacy of a person as claimed in claim 1.

7. The IoT system as claimed in claim 6,
wherein, after detecting a protection signal emitted by a protective device, the IoT system switches to a protective operating mode to protect the privacy of the person from the recording, processing, storage, dissemination and evaluation of the personal data of the person in question.

8. The IoT system as claimed in claim 6,
wherein the IoT system provides the person with confirmation of the detection of the protection signal.

9. The IoT system as claimed in claim 7,
wherein the IoT sensors of the IoT system record data only coarsely when in the protective operating mode, or IoT applications of the IoT system only coarsely read out data from the IoT sensors 3-)--and/or immediately transfer these data in a coarse state, discarding the raw data.

10. A data acquisition device for recording data, wherein, when it detects a protection signal that is emitted by a protective device carried by a person as claimed in claim 1, the data acquisition device switches to a protective operating mode to protect the privacy of the person in question.

11. A mobile radio device for a user, having a detector that is integrated into or attached to it for the detection of a protection signal, which is emitted by a protective device carried by the user as claimed in claim 1 and which signals the approval or denial of permission by the user to record and/or process and/or store and/or disseminate and/or evaluate the personal data of the user.

12. A protective signal detector for detecting a predetermined protection signal, which is emitted by a protective device carried by a person as claimed in claim 1 and which signals the approval or denial of permission by the person to record and/or process and/or store and/or disseminate and/or evaluate the personal data of the person.

13. The protective signal detector as claimed in claim 12,
wherein the protective signal detector can be connected to a device via a data interface, wherein the device comprises in particular a portable mobile radio device or a portable data acquisition device.

14. A method for protecting the privacy of a person, having the following steps:
(a) emitting a protection signal by means of a signaling unit of a protective device carried by a person, which is an active signaling unit having a transmitter that transmits a protection signal or is a passive signaling unit that sends back the protection signal upon receipt of a query signal,
wherein the protection signal signals the approval or denial of permission by the person to record and/or process and/or store and/or disseminate and/or evaluate the personal data of the person; and
(b) detecting the transmitted protection signal by means of a detector of an IoT system, which then switches to a protective operating mode to protect the privacy of the person.
